(19) United States
(12) Patent Application Publication
(10) Pub. No.: US 2007/0122732 A1
(43) Pub. Date: May 31, 2007

(54) Method of preparing toner and toner prepared using the method

(75) Inventors: Min-young Cheong, Seoul (KR); Kyung-yol Yon, Seongnam-si (KR); Chang-kook Hong, Suwon-si (KR); Jun-young Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/594,089

(22) Filed: Nov. 8, 2006

(30) Foreign Application Priority Data
Nov. 26, 2005 (KR) 10-2005-0113854

(51) Int. Cl. G03G 9/087

(52) U.S. Cl. 430/109.3; 430/137.15; 430/137.17; 399/159

(57) ABSTRACT

A method of preparing a toner is provided, including: preparing a toner composition including a macromonomer having a hydrophilic group, a hydrophobic group and one or more reactive functional groups, and one or more polymerizable monomers; emulsion polymerizing the toner composition and mixing one or more materials selected from the group consisting of a colorant dispersion and a wax dispersion, dispersed in a nonionic reactive emulsifier; and separating and drying a emulsion polymerized toner composition. A toner prepared is also provided using the method. An image forming method, and an image forming apparatus are provided employing the toner. Using the method, polymerized toner particles are prepared through a simplified process, and a colorant and wax are dispersed easily inside the toner particles.

### CROSS-REFERENCE TO RELATED PATENT APPLICATION

This application claims the benefit of Korean Patent Application No. 10-2005-0113854, filed on Nov. 26, 2005, in the Korean Intellectual Property Office, the disclosure of which is hereby incorporated by reference in its entirety.

### BACKGROUND OF THE INVENTION

1. Field of the Invention

The present invention relates to a method of preparing a toner and to the resulting toner. The invention is also directed to a method of preparing a toner in an easy preparation process. The toner has superior dispersibilities of wax and a colorant. The invention is further directed to an image forming method and an image forming apparatus employing the toner.

2. Description of the Related Art

In an electrophotographic process or an electrostatic recording process, a developer used to form an electrostatic image or an electrostatic latent image may be a two-component developer formed of a toner and carrier particles or a one-component developer formed of a toner only, without carrier particles. The one-component developer may be a magnetic one-component developer having magnetic properties or a nonmagnetic one-component developer not having magnetic properties. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toners include pulverization or polymerization. In the pulverization method, the toner is obtained by melt mixing synthetic resins with colorants and, if needed, other additives. The mixture is pulverized and the particles are classified to obtain a desired size of particles. In the polymerization method, a polymerizable monomer composition is manufactured by uniformly dissolving or dispersing a polymerizable monomer, a colorant, a polymerization initiator and, if needed, various additives such as a cross-linking agent and an antistatic agent. Next, the polymerizable monomer composition is dispersed in an aqueous dispersive medium which includes a dispersion stabilizer using an agitator to form minute liquid drop particles. Subsequently, the temperature is increased and suspension polymerization is performed to obtain a polymerized toner having coloring polymer particles of a desired size.

In an image forming apparatus such as an electrophotographic apparatus or an electrostatic recording apparatus, an electrostatic latent image is formed through light-exposure on the surface of a photoreceptor which is uniformly charged. A toner is attached to the electrostatic latent image, and a resulting toner image is transferred to a transfer medium such as a paper through several processes such as heating, pressing, solvent steaming, etc. In most fixing processes, the transfer medium with the toner image passes through fixing rollers and pressing rollers, and by heating and pressing, the toner image is fused to the transfer medium.

Improvements in preciseness and minuteness are required for images formed by an image forming apparatus such as an electrophotocopier. Conventionally, a toner used in an image forming apparatus is usually obtained by pulverization of the toner material. When using pulverization, it is likely to form coloring particles with a wide range of particle sizes. Hence, to obtain satisfactory developer properties, there is a need to classify the coloring particles obtained by pulverization according to size to narrow particle size distribution. However, it is difficult to precisely control the particle size distribution using a conventional mixing/pulverizing process in the manufacture of toner particles suitable for an electrophotographic process or electrostatic recording process. Also when preparing a minute particle toner, a toner preparation yield is low due to a classification process. In addition, there is a limit to a change/adjustment of a toner design for obtaining desirable charging and fixing properties. Accordingly, polymerized toners, in which the size of particles is easy to control and which do not need to go through a complex manufacturing process such as classification, have come into the spotlight recently.

When a toner is prepared by polymerization, the desired size distribution of particles is obtained without performing pulverization or classification.

U.S. Pat. No. 6,033,822 in the name of Hasegawa et al. discloses a polymerized toner including a core formed of colored polymer particles and a shell covering the core in molecules, wherein the polymerized toner is prepared by suspension polymerization. However, it is still difficult to adjust the shape of the toner and the sizes of the particles using the process. Also, the process produced a wide particle size distribution.

U.S. Pat. No. 6,258,911 in the name of Michael et al. discloses a bi-functional polymer having a narrow polydispersity and an emulsion-condensation polymerization process for manufacturing a polymer having covalently bonded free radicals on each of its ends. However, even when this method is used, a surfactant can cause an adverse effect, and it is difficult to control the size of latex.

### SUMMARY OF THE INVENTION

The present invention provides a method of preparing a toner in which polymerized toner particles are produced in a simplified process and where dispersion of a colorant and wax inside the toner particles is easy.

The present invention also provides a toner having superior properties in particle size control, storage property, and durability.

The present invention also provides an image forming method in which a high quality image can be fused at a low temperature by using a toner having superior properties in particle size control, storage property, and durability.

The present invention also provides an image forming apparatus in which a high quality image can be fused at a low temperature by using a toner having superior properties in particle size control, storage property, and durability.

According to an aspect of the present invention, a method of preparing a toner is provided, including: preparing a toner composition including a macromonomer having a hydrophilic group, a hydrophobic group and one or more reactive functional groups, and one or more polymerizable monomers; emulsion polymerizing the toner composition and mixing one or more materials selected from the group consisting of a colorant dispersion and a wax dispersion, dispersed in a nonionic reactive emulsifier; and separating and drying a emulsion polymerized toner composition.

According to another aspect of the present invention, a toner prepared by preparing a toner composition including a macromonomer having a hydrophilic group, a hydrophobic group and one or more reactive functional groups, and one or more polymerizable monomers, emulsion polymerizing the toner composition and mixing one or more materials selected from the group consisting of a colorant dispersion and a wax dispersion, dispersed in a nonionic reactive emulsifier to form a copolymer, and separating and drying a emulsion polymerized toner composition.

According to another aspect of the present invention, an image forming method is provided including: forming a visible image by disposing a toner on an photoreceptor surface where an electrostatic latent image is formed; and transferring the visible image to a transfer medium, wherein the toner is prepared by preparing a toner composition including a macromonomer having a hydrophilic group, a hydrophobic group and one or more reactive functional groups, and one or more polymerizable monomers, emulsion polymerizing the toner composition and mixing one or more materials selected from the group consisting of a colorant dispersion and a wax dispersion, the materials dispersed in a nonionic reactive emulsifier, and separating and drying a emulsion polymerized toner composition.

According to another aspect of the present invention, an image forming apparatus is provided including: an organic photoreceptor; an image forming unit to form an electrostatic latent image on a surface of the organic photoreceptor; a toner cartridge to contain a toner; a toner supplying unit to supply the toner to the surface of the organic photoreceptor to develop an electrostatic latent image on the surface of the organic photoreceptor into a toner image; and a toner transferring unit to transfer the toner image on the surface of the organic photoreceptor to a transfer medium, wherein the toner is prepared by preparing a toner composition including a macromonomer having a hydrophilic group, a hydrophobic group and one or more reactive functional groups, and one or more polymerizable monomers, emulsion polymerizing the toner composition and mixing one or more materials selected from the group consisting of a colorant dispersion and a wax dispersion, the materials dispersed in a nonionic reactive emulsifier, and separating and drying a emulsion polymerized toner composition.

According to the present invention, by dispersing a colorant and wax to form a polymer using a simplified process, dispersibilities of the colorant and the wax are improved. Also, by simplifying the preparation processes, production costs are reduced.

### BRIEF DESCRIPTION OF THE DRAWING

The above and other features and advantages of the present invention will become more apparent by describing in detail exemplary embodiments thereof with reference to the attached drawing in which:

FIG. 1 is a schematic diagram of an image forming apparatus employing a toner prepared using a method according to an embodiment of the present invention.

### DETAILED DESCRIPTION OF THE INVENTION

An embodiment of the present invention provides a method of preparing a toner, including: preparing a toner composition including a macromonomer having a hydrophilic group, a hydrophobic group and one or more reactive functional groups, and one or more polymerizable monomers; emulsion polymerizing the toner composition and mixing one or more materials selected from the group consisting of a colorant dispersion and a wax dispersion, dispersed in a nonionic reactive emulsifier; and separating and drying an emulsion polymerized toner composition.

The present embodiment relates to a method of preparing a toner latex used for a polymerized toner, wherein a high molecular toner latex for a polymerized toner containing wax and a colorant can be prepared easily using a one-step process. Such a preparation process results in a toner having superior dispersibilities of the wax and the colorant, and small sized toner particles are obtained with high yield. Also, the preparation process is suitable for preparing toner for a high speed, high definition printer having low temperature image fixation. The toner has easy regulation, image storability and fixation properties.

A conventional preparation process for making a polymerized toner using an emulsifier uses an ionic emulsifier, generally an anionic emulsifier to separately prepare a wax dispersion and a colorant dispersion. Using the emulsifier, the high molecular toner latex is completed and then dispersed with the wax dispersion and the colorant dispersion. Subsequently, through an aggregation process, toner particles are prepared.

Another preparation process includes polymerizing a high molecular toner latex and then emulsion polymerizing the high molecular toner latex with a wax-monomer dispersion. Using the emulsifier, the high molecular toner latex is aggregated with a colorant dispersion dispersed during the aggregation process to prepare toner particles.

According to the present embodiment, the toner latex having a colorant and/or wax may be prepared using a one-step polymerization process. The present embodiment reduces the preparation process by mixing the colorant dispersion and/or the wax dispersion, both being dispersed in a nonionic reactive emulsifier, during the emulsion polymerization. Also, dispersion of the colorant and/or the wax is easy. Since the colorant and/or the wax is mixed during a polymerization reaction, the colorant and/or the wax may be mixed in a dispersion state in a medium for easy dispersion. The medium may be an aqueous solution, an organic solvent, or a mixture of both. In addition, when preparing the dispersion of wax, one or more polymerizable monomers may be added to the dispersion. Also, when preparing the dispersions of the wax and colorant, a macromonomer including a hydrophilic group, a hydrophobic group and one or more reactive functional groups may be added to the dispersion. By using a polymerizable monomer and/or macromonomer with the dispersion during the polymerization reaction, dispersibility and stability of toner particles, the coloring agent, and wax may be increased, and the properties of the final toner may be improved.

During the polymerization reaction, one or more of the colorant dispersion and the wax dispersion, both being dispersed in the nonionic reactive emulsifier, may be introduced into the reactor. An initiator also may be added to the reactor. The initiator enables the polymerization reaction to continue and a reaction time may be determined based on the temperature of the reaction, the speed of the reaction, and a conversion factor. After the reaction, a monomer may be further introduced to regulate the durability and other properties of the toner. After the reaction is completed, the form and the size of the toner particles may be regulated using an aggregation process. When the desired form and size are obtained, the toner particles are separated and dried using a filtration process. An additive, such as silica may be added to the dried toner, and the amount of an electric charge thereof may be regulated to obtain the final toner.

The nonionic emulsifier according to the present embodiment of the present invention may use, but is not limited to, alkyl polyethoxy acrylate, alkyl polyethoxy methacrylate, aryl polyethoxy acrylate, and aryl polyethoxy methacrylate.

The macromonomer according to the present embodiment of the present invention is an amphipathic material having both a hydrophilic group and a hydrophobic group, and a polymer or an oligomer having at least one reactive functional group at the end. The hydrophilic group of the macromonomer chemically combined on the surface of the particle increases the long term stability of the toner particle by providing steric stability, and can control the particle size according to the amount or molecular weight of the injected macromonomer. The hydrophobic group promotes the emulsion polymerization by existing on the surface of toner particles. The macromonomer can form a copolymer by binding with a polymerizable monomer in the toner composition in various ways, such as grafting, branching or cross-linking. The toner latex according to the present embodiment can simplify the preparation process and reduce production costs of the polymerized toner.

The weight average molecular weight of the macromonomer is in the range of about 100 to about 100,000, and preferably in the range of about 1,000 to about 10,000. When the weight average molecular weight of the macromonomer is less than 100, the properties of the toner may not be improved or the macromonomer may not operate properly as a stabilizer. Also, when the weight average molecular weight of the macromonomer is greater than 100,000, a reaction conversion rate may be low.

The macromonomer according to the current embodiment of the present invention may be, for example, a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate and polyester methacrylate, but is not limited thereto.

The amount of the macromonomer used in the current embodiment of the present invention may be in the range of 1 to 50 parts by weight based on 100 parts by weight of the toner composition. When the amount of the macromonomer is less than 1 part by weight based on 100 parts by weight of the toner composition, the stability of the particle distribution is low, and when the amount of the macromonomer exceeds 50 parts by weight based on 100 parts by weight of the toner composition, the property of the toner deteriorates.

The polymerizable monomer used in the current embodiment of the present invention may be a monomer selected from the group consisting of a vinyl monomer, a polar monomer having a carboxyl group, a monomer having an unsaturated polyester group and a monomer having a fatty acid group.

The polymerizable monomer, may be formed of at least one material selected from the group consisting of styrene-based monomer such as styrene, vinyltoluene, and α-methylstyrene; acrylic acid and methacrylic acid; (meth)acrylic acid derivative such as methylacrylate, ethylacrylate, propylacrylate, butylacrylate, 2-ethylhexylacrylate, dimethylaminoethylacrylate, methylmethacrylate, ethylmethacrylate, propylmethacrylate, butylmethacrylate, 2-ethylhexylmethacrylate, dimethylaminoethyhnethacrylate; (meth)acrylic acid derivative of amide selected from the group consisting of acrylonitrile, methacrylonitrile, acrylamide and methacrylamide; ethylenically unsaturated monoolefin such as ethylene, propylene and butylene; halogenated vinyl such as vinyl chloride, vinylidene chloride and vinyl fluoride; vinyl ester such as vinyl acetate and vinyl propionate; vinyl ether such as vinyl methyl ether and vinyl ethyl ether; vinyl ketone such as vinyl methyl ketone and methyl isopropenyl ketone; vinyl compound having nitrogen such as 2-vinyl pyridine, 4-vinyl pyridine and N-vinyl pyrrolidone, but is not limited thereto.

The amount of the polymerizable monomer used in the current embodiment of the present invention is in the range of about 3 to about 50 parts by weight based on 100 parts by weight of the toner composition. When the amount of the polymerizable monomer is less than 3 parts by weight based on 100 parts by weight of the toner composition, the yield is low. When the amount of the polymerizable monomer exceeds 50 parts by weight based on 100 parts by weight of the toner composition, the stability of the toner composition is low.

The medium used in the present embodiment may be an aqueous solution, an organic solvent and a mixture of both.

The detailed process of preparing a polymerized toner according to the present embodiment of the present invention is as follows.

While purging a reactor with nitrogen gas, a mixture of a medium such as distilled deionized water (or a mixture of water and an organic solvent) and a macromonomer is introduced into the reactor, and the mixture is heated while stirring. At this time, an electrolyte such as NaCl or other ionic salt can be added to control the ionic strength of a reaction medium. When the temperature inside the reactor reaches an appropriate value, an initiator, such as a water soluble free radical initiator, is injected. Subsequently, at least one polymerizable monomer introduced into the reactor semicontinuously, may be with a chain transfer agent. To control the reaction rate and the degree of dispersion, the polymerizable monomer is supplied sufficiently slowly using a starved feeding process.

The colorant is mixed with deionized water and a nonionic reactive emulsifier, and dispersed using a disperser to form a colorant dispersion. The colorant dispersion may include a macromonomer. In order not to affect the reaction, the colorant dispersion is introduced to the reactor during the polymerization reaction and the polymerization reaction is continued. If the feed of the colorant dispersion is too fast, a conversion factor of the reaction may be effected, and if the feed is too slow, a content or dispersibility of the colorant may not be good. After the polymerization reaction is advanced, the feed time of the wax is determined based on the speed of the reaction and the conversion factor. After the reaction has progressed to some extent, the wax dispersed in mixed monomers is introduced to the reactor, and the initiator is further introduced to continue the reaction. The polymerization reaction time is in the range of 6 hours to 12 hours, and is determined based on the temperature and the experiment condition, by measuring the speed of the reaction and the conversion factor. After the reaction, a capsulized toner may be prepared by further introducing the monomer to regulate the durability and other properties of the toner particles. The size and the form of the toner particles completed after the reaction may be regulated using a cohesion process. After the desired size and form are obtained, the toner particles may be separated and dried using a filtration process. An additive such as silica, etc. may be further added and the amount of electric charge of the toner particles may be regulated to obtain the final toner.

An amphipathic macromonomer can act not only as a comonomer but also as a stabilizer. The reaction between initial radicals and monomers forms oligomer radicals, and provides an in situ stabilizing effect. The initiator decomposed by heat forms a radical, reacts with a monomer unit in an aqueous solution to form an oligomer radical, and increases hydrophobicity. The hydrophobicity of the oligomer radical accelerates the diffusion inside the micelle, accelerates the reaction with polymerizable monomers and facilitates a copolymerization reaction with a macromonomer.

Owing to the hydrophilicity of an amphipathic macromonomer, a copolymerization reaction can more easily occur in the vicinity of the surface of toner particles. The hydrophilic portion of the macromonomer located on the surface of the particle increases the stability of the toner particle by providing steric stability, and can control the particle size according to the amount or molecular weight of the injected macromonomer. Also, the functional group which reacts on the surface of the particle can improve the frictional electricity properties of the toner.

The toner according to the present embodiment includes a colorant and/or wax. The colorant may be carbon black or aniline black in the case of a black toner. Also, it is easy to produce a color toner with a nonmagnetic toner according to an embodiment of the present invention. In the case of a color toner, carbon black is used as a colorant for black, and a yellow colorant, a magenta colorant and a cyan colorant are further included as colorants for the colors.

The yellow colorant may be a condensed nitrogen compound, an isoindolinone compound, an anthraquinone compound, an azo metal complex, or an aryl imide compound. For example, C.I. pigment yellow 12, 13, 14, 17, 62, 74, 83, 93, 94, 95, 109, 110, 111, 128, 129, 147, 168, 180, etc. may be used.

The magenta colorant may be a condensed nitrogen compound, anthraquinone, a quinacridone compound, a lake pigment of basic dye, a naphthol compound, a benzoimidazole compound, a thioindigo compound, or a perylene compound. For example, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, etc. may be used.

The cyan colorant may be a copper phthalocyanine compound or a derivative thereof, an anthraquinone compound, or a lake pigment of basic dye. For example, C.I. pigment blue 1, 7, 15, 15:1, 15:2, 15:3, 15:4, 60, 62, 66, etc. may be used.

These colorants may be used alone or in combinations of two or more types. A desired colorant is selected considering the desired color, saturation, brightness, weatherability, and dispersibility in a toner.

The amount of the colorant may be in the range of about 0.1 to about 20 parts by weight based on the 100 parts by weight of a polymerizable monomer. The amount of the colorant is not particularly limited as long as it is sufficient to color the toner. When the amount of the colorant is less than 0.1 parts by weight, the coloring is insufficient. When the amount of the colorant exceeds 20 parts by weight, the production costs of the toner increases and the toner is unable to obtain enough triboelectric charge.

A suitable wax which provides a desired characteristic of the final toner compound may be used. The wax may be polyethylene wax, polypropylene wax, silicon wax, paraffin wax, ester wax, carnauba wax or metallocene wax, but is not limited thereto. The melting point of the wax may be in the range of about 50 to about 150° C. Wax components physically adhere to the toner particles, but do not covalently bond with the toner particles. The toner fixes to a final image receptor at a low fixation temperature and has superior final image durability and antiabrasion property.

The toner composition may further include at least one material selected from the group consisting of an initiator, a chain transfer agent, a release agent, and a charge control agent.

A radical formed by an initiator reacts with the polymerizable monomer, and the reactive functional group of the macromonomer, and may form a copolymer.

Examples of the radical polymerized initiator include persulfates, such as potassium persulfate, ammonium persulfate, etc.; azo compounds, such as 4,4-azobis(4-cyanovaleric acid), dimethyl-2,2′-azobis(2-methylpropionate), 2,2-azobis(2-amidinopropane)dihydrochloride, 2,2-azobis-2-methyl-N-1,1-bis(hydroxymethyl)-2-hydroxyethylpropionamide, 2,2′-azobis(2,4-dimethylvaleronitrile), 2,2′-azobisisobutyronitrile, 1,1′-azobis(1-cyclohexanecarbonitrile), etc.; peroxides, such as methylethylperoxide, di-t-butylperoxide, acetylperoxide, dicumylperoxide, lauroylperoxide, benzoylperoxide, t-butylperoxide-2-ethylhexanoate, di-isopropylperoxydicarbonate, di-t-butylperoxyisophthalate, etc. Also, an oxidation-reduction initiator, which is a combination of a polymerized initiator and a reducing agent, may be used.

The chain transfer agent is a material converting a chain carrier during a chain reaction. The new chain carrier has considerably reduced activity compared to the previous chain carrier. The degree of polymerization of the monomer may be reduced or the new chain reaction may be initiated using the chain transfer agent. Also, the range of the molecular weight may be regulated using the chain transfer agent.

The chain transfer agent may include, but is not limited to, a compound having sulfur such as dodecanethiol, thioglycolic acid, thioacetic acid and mercaptoethanol; a compound of phosphorous acid such as phosphorous acid and sodium phosphorous acid; a compound of hypophosphorous acid such as hypophosphorous acid and sodium hypophosphorous acid; and alcohol such as methylalcohol, ethylalcohol, isopropylalcohol, and n-butyl alcohol.

The release agent protects a photoreceptor and prevents deterioration of developing properties, and thus may be used for the purpose of obtaining a high quality image. A release agent according to an embodiment of the present invention may use a solid fatty acid ester material with high purity. For example, a low molecular weight polyolefin, such as low molecular weight polyethylene, low molecular weight polypropylene, low molecular weight polybutylene, etc.; paraffin wax; or a multifunctional ester compound, etc. may be used. The release agent in an embodiment of the present invention may be a multifunctional ester compound formed of an alcohol having at least three functional groups and a carboxylic acid.

The polyhydric alcohol with at least three functional groups may be an aliphatic alcohol, such as glycerin, pentaerythritol, pentaglycerol, etc.; an alicyclic alcohol, such as chloroglycitol, quersitol, inositol, etc.; an aromatic alcohol, such as tris(hydroxymethyl) benzene, etc.; a sugar, such as D-erythrose, L-arabinose, D-mannose, D-galactose, D-fructose, sucrose, maltose, lactose, etc.; or a sugar-alcohol, such as erythrite, etc.

The carboxylic acid may be an aliphatic carboxylic acid, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, tetrolic acid, etc.; an alicyclic carboxylic acid, such as cyclohexanecarboxylic acid, hexahydroisophthalic acid, hexahydroterephthalic acid, 3,4,5,6-tetrahydrophthalic acid, etc.; or an aromatic carboxylic acid, such as benzoic acid, cumic acid, phthalic acid, isophthalic acid, terephthalic acid, trimeth acid, trimellitic acid, hemimellitic acid, etc.

The charge control agent may be formed of a material selected from the group consisting of a salicylic acid compound containing a metal, such as zinc or aluminum, a boron complex of bisdiphenylglycolic acid, and silicate. More particularly, dialkyl salicylic acid zinc or boro bis(1,1-diphenyl-1-oxo-acetyl potassium salt) may be used.

The polymerizing reaction may be performed for 3 to 12 hours according to the temperature. Particles obtained as a product of the reaction are filtered, separated and dried. At this time, an agglomeration process may be performed to control the particle size. An additive may be further added to the dried toner for use in a laser printer. The average volumetric particle size of the toner prepared according to an embodiment of the present invention may be in the range of 0.5 to 20 μm, and preferably, in the range of 5 to 10 μm.

Another embodiment of the present invention provides a toner prepared by preparing a toner composition including a macromonomer having a hydrophilic group, a hydrophobic group and one or more reactive functional groups, and one or more polymerizable monomers, emulsion polymerizing the toner composition further mixing one or more materials selected from the group consisting of a colorant dispersion and a wax dispersion, dispersed in a nonionic reactive emulsifier to form a copolymer, and separating and drying a emulsion polymerized toner composition.

A radical formed by an initiator reacts with the polymerizable monomer, and the reactive functional group of the macromonomer, and may form a copolymer. The copolymer may be formed by copolymerizing at least one monomer selected from the group consisting of a vinyl monomer, a polar monomer having a carboxyl group, a monomer having an unsaturated polyester group and a monomer having a fatty acid group. The weight average molecular weight of the copolymer may be in the range of about 2,000 to about 200,000.

The weight average molecular weight of the macromonomer may be in the range of about 100 to about 100,000, and is preferably in the range of about 1,000 to about 10,000. The macromonomer may be formed of a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate and polyester methacrylate, but is not limited thereto.

The average volumetric particle size of the obtained toner particles may be in the range of about 0.5 to about 20 μm, and preferably in the range of about 5 to about 10 μm.

Another embodiment of the present invention provides an image forming method including: forming a visible image by disposing a toner on an photoreceptor surface where an electrostatic latent image is formed; and transferring the visible image to a transfer medium, wherein the toner is prepared by preparing a toner composition including a macromonomer having a hydrophilic group, a hydrophobic group and one or more reactive functional groups, and one or more polymerizable monomers, emulsion polymerizing the toner composition further mixing one or more materials selected from the group consisting of a colorant dispersion and a wax dispersion, the materials dispersed in a nonionic reactive emulsifier, and separating and drying a emulsion polymerized toner composition.

An electrophotographic image forming process includes a charging process, a light-exposing process, a developing process, a transferring process, a fusing process, a cleaning process and an erasing process, which are series of processes to form an image on an image receptor.

In the charging process, the photoreceptor is covered with electric charges of desired polarity, either negative or positive, by a corona or a charging roller. In the light-exposing process, an optical system, generally a laser scanner or an array of diodes, forms a latent image corresponding to a final visual image to be formed on an image receptor by selectively discharging the charging surface of the photoreceptor in an imagewise manner. Electromagnetic radiation (hereinafter, “light”) may include infrared radiation, visible rays and ultraviolet radiation.

In the developing process, in general, the toner particles with suitable polarity contact the latent image on the photoreceptor, and typically, an electrically biased developer which has a potential with the same polarity as the toner is used. The toner particles move to the photoreceptor, selectively adhere to the latent image through static electricity and form a toner image on the photoreceptor.

In the transferring process, the toner image is transferred from the photoreceptor to a desired final image receptor. Sometimes an intermediate transferring element is used to effect the transfer of the toner image from the photoreceptor to the final image receptor.

In the fusing process, the toner image is fused to the final image receptor by melting or softening the toner particles by heating the toner image on the final image receptor. Alternatively, the toner can be fixed to the final image receptor under high pressure while being heated or without heating.

In the cleaning process, the toner particles remaining on the photoreceptor are removed. In the erasing process, an electric charge on the photoreceptor is exposed to light of a certain wavelength, and the electric charge is substantially decreased to a uniform low value. Consequentially, a residue of the latent image is removed and the photoreceptor is prepared for the next image forming cycle.

Another embodiment of the present invention provides an image forming apparatus including: an organic photoreceptor; an image forming unit to form an electrostatic latent image on a surface of the organic photoreceptor; a toner cartridge to contain a toner; a toner supplying unit to supply the toner to the surface of the organic photoreceptor to develop an electrostatic latent image on the surface of the organic photoreceptor into a toner image; and a toner transferring unit to transfer the toner image on the surface of the organic photoreceptor to a transfer medium, wherein the toner is prepared by preparing a toner composition including a macromonomer having a hydrophilic group, a hydrophobic group and one or more reactive functional groups, and one or more polymerizable monomers, emulsion polymerizing the toner composition and mixing one or more materials selected from the group consisting of a colorant dispersion and a wax dispersion, the materials dispersed in a nonionic reactive emulsifier, and separating and drying a emulsion polymerized toner composition.

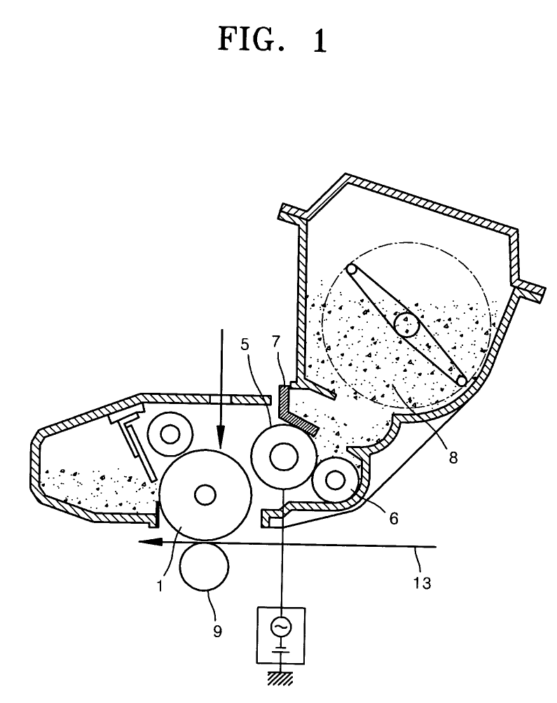

FIG. 1 is a schematic diagram of a non-contact developing type image forming apparatus using a toner prepared using the method according to an embodiment of the present invention. The operating principles of the image forming apparatus are explained below.

A developer 8, which is a nonmagnetic one-component developer, is supplied to a developing roller 5 through a feeding roller 6 formed of an elastic material such as polyurethane form and sponge. The developer 8 supplied to the developing roller 5 reaches a contact point between the developing roller 5 and a developer regulation blade 7 as the developing roller 5 rotates. The developer regulation blade 7 is formed of an elastic material such as metal, rubber, etc. When the developer 8 passes the contact point between the developing roller 5 and the developer regulation blade 7, the developer 8 is smoothed to form a thin layer and the developer 8 is sufficiently charged. The developing roller 5 transfers the thin layer of the developer 8 to a developing domain where the developer 8 is developed on the electrostatic latent image of a photoreceptor 1, which is a latent image carrier.

The developing roller 5 and the photoreceptor 1 face each other with a constant distance therebetween without contact. The developing roller 5 rotates counterclockwise and the photoreceptor 1 rotates clockwise. The developer 8 transferred to the developing domain forms an electrostatic latent image on the photoreceptor 1 according to the intensity of an electric charge generated due to a difference between a voltage applied to the developing roller 5 and a latent image potential of the photoreceptor 1.

The developer 8 developed on the photoreceptor 1 reaches a transferring device 9 as the photoreceptor 1 rotates. The developer 8 developed on the photoreceptor 1 is transferred through corona discharging or by a roller to a printing paper 13 as the printing paper 13 passes between the photoreceptor 1 and the transferring device 9 by the transferring device 9 to which a high voltage with an opposite polarity to the developer 8 is applied, and thus forms an image.

The image transferred to the printing paper 13 passes through a fusing device (not shown) that provides high temperature and high pressure, and the image is fused to the printing paper 13 as the developer 8 is fused to the printing paper 13. Meanwhile, remaining developer 8 on the developing roller 5 which is not developed is taken back by the feeding roller 6 contacting the developing roller 5. The above processes are repeated.

The present invention will now be described in greater detail with reference to the following examples. The following examples are for illustrative purposes only and are not intended to limit the scope of the invention.

### EXAMPLES

### Example 1

While purging the inside of a 1 L reactor with nitrogen gas, 470 g of distilled deionized water and 5 g of polyethyleneglycol ethylether methacrylate (PGE-EEM, available from Aldrich) were introduced into the reactor, and stirred at 250 RPM and heated. When the temperature inside the reactor reached 82° C., 2.0 g of potassium persulfate (available from KPS) dissolved in 50 g of deionized water was introduced into the reactor as a reaction initiator. Subsequently, 100 g of mixed monomers of styrene, butylacrylate and methacrylic acid at the ratio of 7:2:1 and 2.9 g of dodecanethiol as the chain transfer agent, were added to the reactor using a starved feeding process. 30 g of cyan pigment, PB 15:3, was dispersed in a dispersing mixer at a rotation of 4,000 RPM for about 2 hours with a mixture of 130 g of distilled water and 15 g of RN-10 emulsifier (available from DAI-ICHI KOGYO SEIYAHKU). The average volumetric size of the dispersed pigment particles was 284 nm and the number average size of the dispersed pigment particles was 214 nm. During the polymerization reaction, 33 g of pigment dispersion was introduced to the reactor, and the reaction continued for about 2 hours while stirring the reactor. Here, the size of the toner latex particles and the reaction conversion factor were measured. The size of the toner latex particles was 395 nm and the reaction conversion factor was 81%. 15 g of ester wax was heated in 28.1 g of mixed monomers of styrene, butylacrylate, and methacrylic acid at the ratio of 7:2:1 and 0.9 g of dodecanethiol, slowly cooled and dispersed in 190 g of distilled water and 1.45 g of PEG-EEM, the macromonomers to prepare a wax dispersion. The wax dispersion was introduced to the reactor and 1 g of potassium persulfate as the initiator, dissolved in 40 g of deionized water was added into the reactor. The reaction time was 6 hours, and when the reaction was completed, the resultant was stirred and cooled naturally. The size of the toner latex particles after the reaction was 473 nm and the conversion factor was almost 100%. After the cooling, 10 g of MgCl₂, as a cohesive agent, was dissolved in 20 g of deionized water and added into the reactor and heated to 95° C. When the average volumetric size of the toner latex particles measured about 7 μm, the toner latex particles were cooled and filtered to obtain the toner particles.

### Example 2

A toner composition was prepared in the same manner as in Example 1, except that after 4 hours of the reaction time have passed, monomers for a shell layer, that is, a mixture of styrene, butylacrylate and methacrylic acid, respectively 56 g, 20 g and 4.4 g were introduced into the reactor. The reaction time was 6 hours and the temperature was maintained at 82° C. After 6 hours of the reaction time, heating of the reactor was stopped, the resultant was cooled naturally and aggregated. When the average volumetric size of the prepared toner latex particles measured 7 μm, the toner latex was cooled to obtain toner particles.

### Example 3

Compared to Example 1, when dispersing the Cyan pigment, 15 g of BEM emulsifier (available from Rhodia Co.) was used instead of RN-10. The average volumetric size of the dispersed pigment particles was 260 nm and the number average size of the dispersed pigment particles was 155 nm. The average volumetric size of the prepared toner particles was 6.8 μm and the number average size of the prepared toner particles was 6.6 μm.

### Example 4

Compared to Example 1, when dispersing the Cyan pigment, 15 g of SEM emulsifier (available from Rhodia Co.) was used instead of RN-10. The average volumetric size of the dispersed pigment particles was 159 nm and the number average size of the dispersed pigment particles was 123 nm. The average volumetric size of the prepared toner particles was 7.2 μm and the number average size of the prepared toner particles was 6.8 μm.

### Comparative Example 1

Preparation of Latex

0.5 g of sodium dodecyl sulfate (SDS) as an anionic emulsifier, was mixed in 400 g of ultra-high pure water that was deoxidized to form an aqueous solution. Styrene, butylacrylate and methacrylic acid, which are monomers were mixed together and put in a dropwise adding funnel. The aqueous solution was put into a reactor and heated to 80° C. When the temperature reached 80° C., an initiator, which was a solution of 0.2 g of potassium persulfate in 30 g of ultra-high pure water, was added. After 10 minutes, 30 g of a mixed monomer was dropwise added for about 30 minutes. After allowing a reaction to occur for 4 hours, the heating was stopped and the product was allowed to cool naturally. 30 g of the resultant seed solution was removed and added to 351 g of ultra-high pure water, and the result was heated to 80° C. 17 g of ester wax was heated and dissolved together with 18 g of monomer styrene, 7 g of butylacrylate, 1.3 g of methacrylic acid, and 0.4 g of dodecanethiol. The prepared wax/mixed monomer was added to 220 g of ultra-high pure water in which 1 g of SDS was dissolved, and the result was homogenized for about 10 minutes in an ultrasonic homogenizer. The homogenized emulsified solution was put into the reactor and after about 15 minutes, 5 g of the initiator and 40 g of ultra-high pure water were mixed and added to the reactor. During this time, the reaction temperature was maintained at 82° C. and the reaction was allowed to continue thereafter for about 2 hours and 30 minutes. After the reaction was performed for 2 hours and 30 minutes, 1.5 g of the initiator and 60 g of ultra-high pure water were again added together with a monomer for shell layer formation. The monomer was composed of 56 g of styrene, 20 g of butylacrylate, 4.5 g of methacrylic acid, and 3 g of dodecanethiol. The monomer was dropwise added to the reactor for about 80 minutes. After the reaction was performed for 4 hours, the reaction was stopped and the product was allowed to cool naturally.

Toner Aggregation/Melting Process

318 g of latex particles prepared as described above were mixed with ultra-high pure water in which 0.5 g of an SDS emulsifier was dissolved. 18.2 g of pigment particles (cyan 15:3, 40 solidity %) dispersed by the SDS emulsifier were added to obtain a latex pigment dispersed aqueous solution. While stirring at 250 RPM, the pH of the latex pigment dispersed aqueous solution was titrated to pH 10 using a 10% NaOH buffer solution. 30 g of ultra-high pure water was dissolved in 10 g of MgCl₂ as an aggregating agent, and the result was dropwise added to the latex pigment aqueous solution for about 10 minutes. The temperature of the resultant was increased to 95° C. at a rate of 1° C./min. After about 3 hours of heating, the reaction was stopped and the product was allowed to cool naturally. The average volumetric particle size was about 7.5 μm.

### Comparative Example 2

Preparation of Latex

3.0 g of sodium dodecyl sulfate (SDS) as an anionic emulsifier, was mixed in 700 g of ultra-high pure water that was purged with nitrogen to form an aqueous solution. Styrene, butylacrylate and methacrylic acid, which are monomers were mixed together with 3.0 g of dodecanethiol and put in a dropwise adding funnel. The aqueous solution was put into a reactor and heated to 80° C. When the temperature reached 80° C., an initiator, which was a solution of 1.0 g of potassium persulfate in 30 g of ultra-high pure water, was added. After 10 minutes, 130 g of a mixed monomer was dropwise added for about 30 minutes. After the reaction was performed for 6 hours, the reaction was stopped and the product was allowed to cool naturally.

Toner Aggregation/Melting Process

346 g of latex particles prepared as described above were mixed with 307 g of ultra-high pure water in which 2.0 g of an SDS emulsifier was dissolved. 18.2 g of pigment particles aqueous solution (cyan 15:3, 40 solidity %) dispersed by the SDS emulsifier and a wax dispersion where ester wax is dispersed in SDS emulsifier were mixed. While stirring at 350 RPM, the pH of the latex pigment dispersed aqueous solution was titrated to pH 10 using a 10% NaOH buffer solution. 30 g of ultra-high pure water was dissolved in 10 g of MgCl₂ as an aggregating agent, and the result was dropwise added to the latex pigment aqueous solution for about 10 minutes. The temperature of the result was increased to 95° C. at a rate of 1° C./min. After about 7 hours of heating, the reaction was stopped and the product was allowed to cool naturally. The average volumetric particle size was about 10.5 μm.

The form and size of toner particles were regulated easily and small sized toner particles were prepared using a simplified polymerization process in Examples 1 through 4, compared to Comparative Examples 1 and 2. Hence, optimization of the toner according to a setting of a printer was possible. The results of the granularity range of the dispersed pigment according to Examples 1 through 4 and Comparative Example 1 are shown in Table 1.

TABLE 1

| | Granularity Range of | | | |
|---|---|---|---|---|
| | Dispersed Pigment | | | |
| | Average | Number | Average | |
| | Volumetric | Average | Volumetric | |
| Example | Size | Size | Size/Number | |
| No. | (μm) | (μm) | Average Size | Remark |
| Example 1 | 0.284 | 0.214 | 1.32 | Unimodal |
| Example 2 | 0.284 | 0.214 | 1.32 | Unimodal |
| Example 3 | 0.260 | 0.155 | 1.67 | Unimodal |
| Example 4 | 0.159 | 0.123 | 1.29 | Unimodal |
| Comparative | 0.275 | 0.132 | 2.08 | Bimodal |
| Example 1 | | | | |

As shown in Table 1, in Examples 1 through 4, the granularity range of the dispersed pigment and unimodal range was small compared to Comparative Example 1, so that preparation of stabilized latex was possible.

According to the present invention, polymerized toner particles may be prepared using a simplified process and the dispersion of a colorant and wax inside the toner is easy. The present invention is advantageous in preparing a toner having small sized particles because the size and the form of toner particles are regulated easily. Also, production costs are reduced. Owing to the improved wax dispersibility, fixation of the toner is improved, and anti-offset, a friction electric charge property, and storage stability are superior, which results in high quality images being printed. Also, a polymerized toner with superior properties can be prepared under a high density environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a toner, comprising:
preparing a toner composition including a macromonomer having a hydrophilic group, a hydrophobic group and one or more reactive functional groups, and one or more polymerizable monomers;
emulsion polymerizing the toner composition and mixing one or more materials selected from the group consisting of a colorant dispersion and a wax dispersion, dispersed in a nonionic reactive emulsifier during the polymerizing step to form a polymerized toner; and
separating and drying a emulsion polymerized toner composition.

2. The method of claim 1, wherein the nonionic reactive emulsifier is one or more materials selected from the group consisting of alkyl polyethoxy acrylate, alkyl polyethoxy methacrylate, aryl polyethoxy acrylate, and aryl polyethoxy methacrylate.

3. The method of claim 1, wherein the colorant dispersion comprises a material selected from the group consisting of an aqueous solution, an organic solvent, and mixtures thereof.

4. The method of claim 1, wherein the colorant dispersion further comprises a macromonomer having a hydrophilic group, a hydrophobic group and one or more reactive functional groups.

5. The method of claim 1, wherein the wax dispersion comprises a material selected from the group consisting of an aqueous solution, an organic solvent, and mixtures thereof.

6. The method of claim 1, wherein the wax dispersion further comprises one or more polymerizable monomers.

7. The method of claim 1, wherein the wax dispersion further comprises a macromonomer having a hydrophilic group, a hydrophobic group and one or more reactive functional groups.

8. The method of claim 1, wherein the toner composition further comprises one or more materials selected from the group consisting of an initiator, a chain transfer agent, a charge control agent, and a release agent.

9. The method of claim 1, wherein the toner composition includes an initiator in the emulsion polymerization process.

10. The method of claim 1, wherein the weight average molecular weight of the macromonomer is in the range of about 100 to about 100,000.

11. The method of claim 1, wherein the macromonomer is a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate and polyester methacrylate.

12. The method of claim 1, wherein the amount of the macromonomer is in the range of about 1 to about 50 parts by weight based on 100 parts by weight of the toner composition.

13. The method of claim 1, wherein the polymerizable monomer comprises at least one monomer selected from the group consisting of a vinyl monomer, a polar monomer having a carboxyl group, a monomer having an unsaturated polyester group, and a monomer having a fatty acid group.

14. The method of claim 13, wherein the polymerizable monomer is at least one material selected from the group consisting of a styrene-based monomer selected from the group consisting of styrene, vinyltoluene, and α-methylstyrene; acrylic acid; methacrylic acid; a (meth)acrylic acid derivative selected from the group consisting of methylacrylate, ethylacrylate, propylacrylate, butylacrylate, 2-ethylhexylacrylate, dimethylaminoethylacrylate, methylmethacrylate, ethylmethacrylate, propylmethacrylate, butylmethacrylate, 2-ethylhexylmethacrylate, and dimethylaminoethylmethacrylate; a (meth)acrylic acid derivative of an amide selected from the group consisting of acrylonitrile, methacrylonitrile, acrylamide and methacrylamide; an ethylenically unsaturated monoolefin selected from the group consisting of ethylene, propylene and butylene; a halogenated vinyl selected from the group consisting of vinyl chloride, vinylidene chloride and vinyl fluoride; a vinyl ester selected from the group consisting of vinyl acetate and vinyl propionate; a vinyl ether selected from the group consisting of vinyl methyl ether and vinyl ethyl ether; a vinyl ketone selected from the group consisting of vinyl methyl ketone and methyl isopropenyl ketone; and a vinyl compound having nitrogen selected from the group consisting of 2-vinyl pyridine, 4-vinyl pyridine and N-vinyl pyrrolidone.

15. The method of claim 1, wherein the amount of the polymerizable monomer is in the range of about 3 to about 50 parts by weight based on 100 parts by weight of the toner composition.

16. The method of claim 1, wherein the colorant comprises a material selected from the group consisting of yellow, magenta, cyan and black pigments.

17. A toner obtained by preparing a toner composition including a macromonomer having a hydrophilic group, a hydrophobic group and one or more reactive functional groups, and one or more polymerizable monomers, emulsion polymerizing the toner composition and mixing one or more materials selected from the group consisting of a colorant dispersion and a wax dispersion, dispersed in a nonionic reactive emulsifier to form a copolymer, and separating and drying a emulsion polymerized toner composition.

18. The toner of claim 17, wherein the weight average molecular weight of the copolymer is in the range of about 2,000 to about 200,000.

19. The toner of claim 17, wherein the average volumetric particle size of the toner particles is in the range of about 0.5 to about 20 μm.

20. The toner of claim 17, wherein the nonionic reactive emulsifier is one or more materials selected from the group consisting of alkyl polyethoxy acrylate, alkyl polyethoxy methacrylate, aryl polyethoxy acrylate, and aryl polyethoxy methacrylate.

21. The toner of claim 17, wherein the macromonomer is a material selected from the group consisting of polyethylene glycol (PEG)-methacrylate, PEG-ethyl ether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate and polyester methacrylate.

22. The toner of claim 17, wherein the toner further comprises one or more materials selected from the group consisting of an initiator, a chain transfer agent, a charge control agent, and a release agent.

23. An image forming method comprising:
forming a visible image by disposing the toner of claim 17 on an photoreceptor surface where an electrostatic latent image is formed; and
transferring the visible image to a transfer medium.

24. An image forming apparatus comprising:
an organic photoreceptor;
an image forming unit to form an electrostatic latent image on a surface of the organic photoreceptor;
a toner cartridge to contain the toner of claim 17;
a toner supplying unit to supply the toner to the surface of the organic photoreceptor to develop an electrostatic latent image on the surface of the organic photoreceptor into a toner image; and
a toner transferring unit to transfer the toner image on the surface of the organic photoreceptor to a transfer medium.

25. A method of preparing a toner, comprising:
preparing an aqueous toner composition including a macromonomer, at least one polymerizable monomer and a polymerization initiator, said macromonomer having a hydrophilic group, a hydrophobic group and at least one reactive group,
emulsion polymerizing the toner composition and feeding at least one dispersion into the toner composition during the polymerization to form a copolymer, said at least one dispersion being selected from the group consisting of a colorant, a wax, and mixtures thereof dispersed in a nonionic reactive emulsifier; and
separating and drying the resulting toner.

26. The method of claim 25, wherein the nonionic reactive emulsifier is selected from the group consisting of alkyl polyethoxy acrylate, alkyl polyethoxy methacrylate, aryl polyethoxy acrylate, and aryl polyethoxy methacrylate.

27. The method of claim 25, wherein the wax dispersion and colorant dispersion include a macromonomer having a hydrophilic group, a hydrophobic group, and at least one reactive group.

28. The method of claim 25, wherein the wax dispersion and the colorant dispersion include a polymerizable monomer.

29. The method of claim 25, wherein the wax dispersion and colorant dispersion are an aqueous dispersion, an organic solvent dispersion or an aqueous/organic solvent dispersion.

30. The method of claim 25, wherein the copolymer has a molecular weight of about 2,000 to about 200,000 and the toner has an average particle size of about 0.5 μm to about 20 μm.
